(19) United States
(12) Patent Application Publication
(10) Pub. No.: US 2008/0106744 A1
(43) Pub. Date: May 8, 2008

(54) Beam-directed structure of input device

(76) Inventor: Shu-Feng Lu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/593,578

(22) Filed: Nov. 7, 2006

(51) Int. Cl. G01N 21/47

(52) U.S. Cl. 356/446

(57) ABSTRACT

A beam-directed structure of an input device comprises a light source, a first lens, and a vision-detecting element. The light source provides a projecting beam. The bottom of the first lens has an arch, which is on the path of the projecting beam. The arch adjusts the beam's slope, and the normal of the arch of the first lens is perpendicular to the surface of the object to let the beam focus on the bottom of the first lens and be projected to the surface of the object. The vision-capturing path passes the first lens exactly from the surface of the object and enters the upper part of the first lens. The vision-detecting element mounted on the upper part of the first lens is used to collect the vision from the surface of the object. By focusing on the surface of the object via the first lens, the vision-detecting element can clearly read the vision of the object.

### BACKGROUND OF THE INVENTION

1. Field of the Invention

The present invention relates to a beam-directed structure of an input device and, more particularly, to a beam-directed structure of an input device, in which a lens is disposed between the light source and the surface of an object to cause a refraction phenomenon of the beam that passes the lens so as to adjust the projecting path and let the beam of the light source focus downwards onto the surface of the object, thereby allowing a vision-detecting element to clearly read the vision of the object.

2. Description of Related Art

With continual progress and development of science and technology, computers have become an indispensable part in everyday life of many people. In order to match ever-evolving functions of computers, input devices (e.g., mice, keyboards, and so on) that are essential peripherals of computers are constantly improved to be practical. Exemplified with mice and keyboards, except for a large amount of text inputs, the use frequency of mouse exceeds that of keyboard. Because the mouse has very good flexibility and manipulability, it can assist and replace the bulky keyboard. Especially for the manipulation of multimedia and the Internet, the mouse has its irreplaceable position.

Commercially available mice can generally be divided into mechanical type and optical type. Although mechanical mice have a low technology threshold and are cheap, their tracking balls are subject to wear and dust during the process of rolling, resulting in a reduction of the accuracy.

An optical mouse utilizes a light source (usually a red light source) to illuminate the surface of the object. The reflected light beam is collected in a certain time. Through scanning and collection many times per second, the moving direction and distance of the optical mouse can be calculated out by means of comparison.

FIG. 1 is a cross-sectional view of a conventional optical structure. As shown in FIG. 1, the mouse moves on a flat surface. A light emitting element a is activated to project its light onto a first reflecting surface b1 of a light guide b, and the light is reflected to a second reflecting surface b2 to be reflected again to pass an opening of a base c and be projected onto the surface d of the object formed of an opaque material. When the surface d of the object is an opaque material, the surface d of the object will overlap a first vision axis I so that a vision-capturing element e can exactly capture the vision projected by the light on the surface d of the object onto the first vision axis L A circuit control unit (not shown) can further be used to accurately calculate out the moving distance and direction of the mouse.

As stated above, the vision-capturing structure of the optical mouse needs to let the projecting beam D and the beam R for capturing the vision intersect at a point on the first vision axis I so that the vision-capturing element e can accurately capture the vision signal of the first vision axis I.

As shown in FIG. 2, if the surface d of the object is made of a transparent dielectric material (e.g., glass), because the surface d of the object does not overlap the first vision axis I, when the projecting beam is incident onto the surface d of the object, the projecting beam D will be transmitted through the surface d of the object and intersect a second vision axis I1 below the first vision axis L That is, the projecting beam D and the beam R for capturing the vision cannot intersect on the first vision axis I. Therefore, the optical mouse cannot function on the surface d of the object. In other words, the optical mouse will lose its function on a transparent dielectric object.

In order to improve the above problems, manufacturers have produced another kind of conventional optical mice. As shown in FIG. 3, when the mouse moves on a flat surface and the beam D projected by the light emitting element a is transmitted to the first reflecting surface b1 of the light guide b, the projecting beam D will be exactly reflected to the surface of a beam splitter f along the vertical direction. The beam splitter f is an optical object that can partly reflect and partly transmit the projecting beam D. After reflected by the beam splitter f, the projecting beam D is downwards and vertically transmitted to the surface d of the object below a transparent dielectric object (e.g., glass). The surface d of the object reflects a beam R for capturing the vision to the inner surface of the beam splitter f to let the beam R for capturing the vision overlap the projecting beam D reflected by the beam splitter f and intersect the second vision axis I1 of the surface d of the object below the transparent dielectric object. The beam R for capturing the vision is reflected by the beam splitter f to a lens, and a vision-capturing element e captures the vision affected by the lens.

When the above structure is in use, however, the light signal projected by the light emitting element a is reflected by the light guide b and then split by the beam splitter f to reach the surface d of the object. During the splitting process, most of the light energy is lost from the beam splitter f, causing a low use efficiency of light energy. In particular, in order to let the beam that is transmitted through the transparent dielectric object and reaches the surface d of the object to form the vision from the surface d of the object, it is necessary to enhance the light emission power of the light emitting element a, hence consuming much light energy. In an era of energy shortage, this is a very non-environmental and uneconomic design.

### SUMMARY OF THE INVENTION

An object of the present invention is to provide a beam-directed structure of an input device, in which a first lens is disposed between a light source and the surface of the object to cause a refraction phenomenon of the beam that passes the lens so as to adjust the projecting path and let the beam of the light source focus downwards onto the surface of the object, thereby allowing a vision-detecting element to clearly read the vision of the object.

In order to achieve the above object, the present invention provides a beam-directed structure of an input device, which comprises a light source, a first lens, and a vision-detecting element. The light source provides a projecting beam. The bottom of the first lens has an arch, which is on the path of the projecting beam and used to adjust the beam's slope. The normal of the arch of the first lens is perpendicular to the surface of the object to let the beam focus on the bottom of the first lens and be projected to the surface of the object. The vision-capturing path passes the first lens exactly from the surface of the object and enters the upper part of the first lens. The vision-detecting element mounted on the upper part of the first lens is used to collect the vision from the surface of the object.

By focusing on the surface of the object via the arch of the first lens, the vision-detecting element can clearly read the vision of the object. Based on the vision variation of the moving object's surface, data such as the moving direction and moving distance of the input device on the surface of the object can be determined.

### BRIEF DESCRIPTION OF THE DRAWINGS

The various objects and advantages of the present invention will be more readily understood from the following detailed description when read in conjunction with the appended drawing, in which:

FIG. 1 is a cross-sectional view of a conventional optical structure;

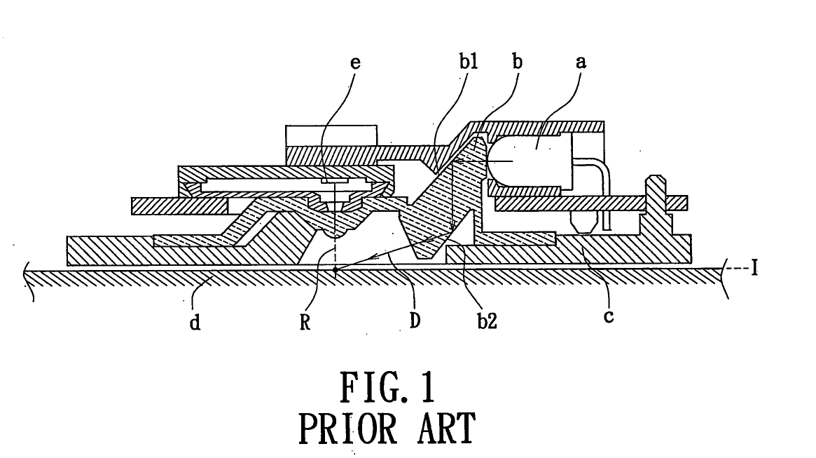

FIG. 2 is a cross-sectional view of another conventional optical structure;

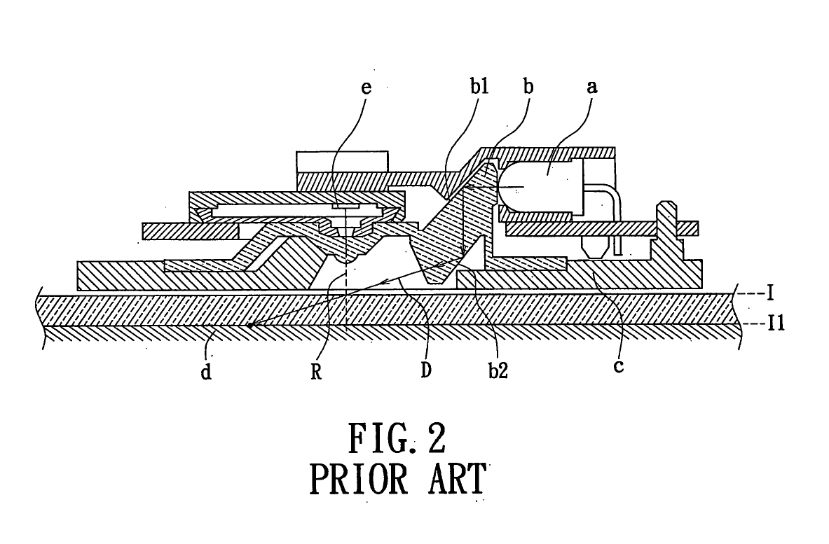

FIG. 3 is a cross-sectional view of yet another conventional optical structure;

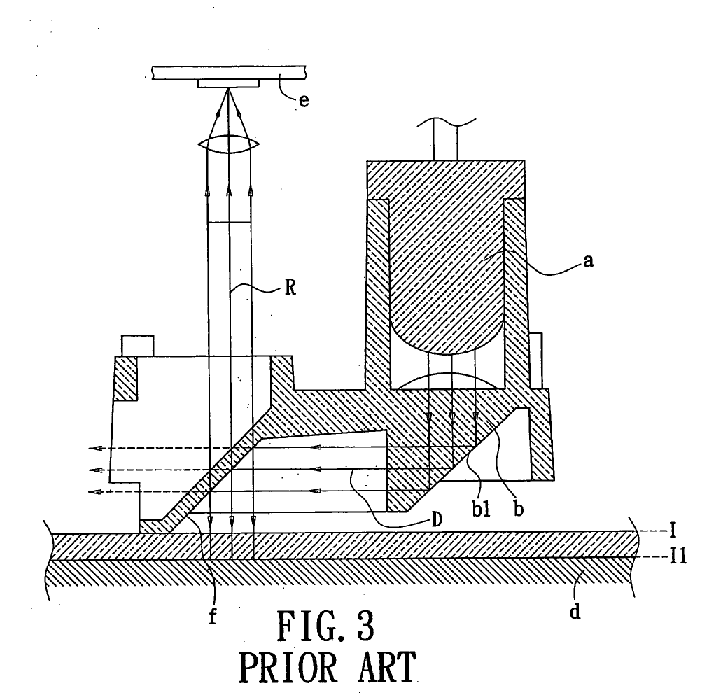

FIG. 4 is a diagram showing the optical path of the beam that passes the first lens according to an embodiment of the present invention;

FIG. 4A is a diagram showing the optical path of the beam that passes the first lens and then enters a transparent dielectric object according to an embodiment of the present invention;

FIG. 5 is a cross-sectional view according to a second embodiment of the present invention;

FIG. 6 is a cross-sectional view according to a third embodiment of the present invention;

FIG. 7 is a cross-sectional view according to a fourth embodiment of the present invention; and

FIG. 8 is a cross-sectional view according to a fifth embodiment of the present invention.

### DETAILED DESCRIPTION OF THE PREFERRED EMBODIMENTS

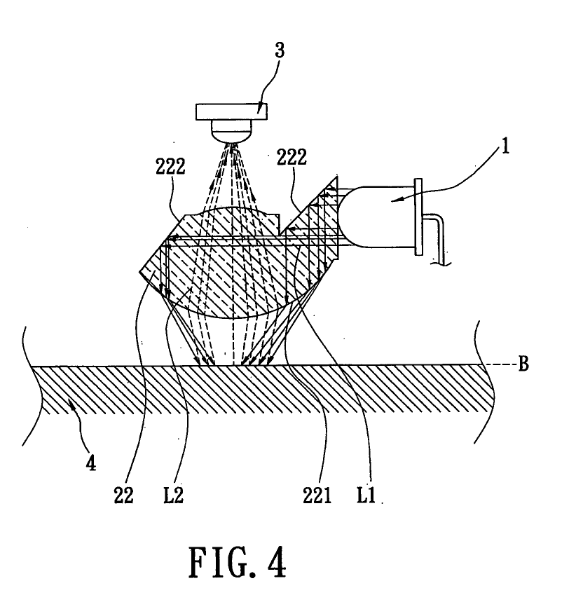

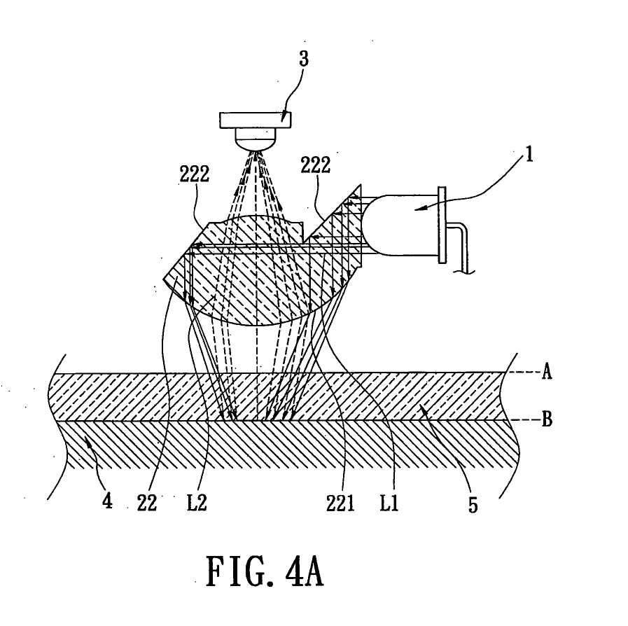

As shown in FIG. 4, the present invention provides a beam-directed structure that is disposed in an input device. The beam-directed structure comprises a light source 1, a first lens 22 and a vision-detecting element 3.

The light source 1 can be a visible or invisible light source. The specific structure of the light source 1 can adopt a laser diode or a light-emitting diode. The light source 1 is mainly used to provide a projecting beam. The projecting direction of the light source is horizontal.

The first lens 22 corresponds to the beam projecting path L1 of the light source 1 and the vision-capturing path L2. The first lens 22 is a convex lens. An arch 221 is formed at the bottom of the first lens 22. The arch is on the path of the projecting beam, and is used to adjust the beam's slope. A slanting prism 222 is formed at each side of the upper part of the first lens 22 and opposite to the arch 221. The slanting prisms 222 are on the beam projecting path L1 of the beam emitted by the light source 1, and are used to guide the beam to be reflected to the arch 22 of the first lens 22 so as to focus the beam onto the bottom of the first lens 22, i.e., the object's surface 4. The normal of the first lens 22 is perpendicular to the object's surface 4 to let the vision on the object's surface 4 pass the first lens 22 along the vision-capturing path L2 and focus onto the upper part of the first lens 22.

The vision-detecting element 3 is mounted on the upper part of the first lens 22, and is used to capture the vision from the object's surface 4 along the vision-capturing path L2.

As shown in FIG. 4A, the slanting prisms 22 disposed around the first lens 22 are on the beam projecting path L1. Light of the light source 1 along the beam projecting path L1 can be guided by the slanting prisms 222 to enter the arch 221 of the first lens 22 after one or more times of reflection, thereby accomplishing the function of guiding the beam to the arch 221. The arch 221 of the first lens 22 causes a refraction phenomenon of centripetally concentrating the beam on the beam projecting path L1 to focus on the object's surface 4 below a transparent dielectric object 5 (glass). Therefore, the beam can concentrate and penetrate a first vision axis A on the surface of the transparent dielectric object 5 and project to a second vision axis B on the object's surface 4 below. The vision of the object's surface 4 penetrates the transparent dielectric object 5 along the vision-capturing path L2 and passes the first lens 22, and then is incident to the vision-detecting element 3 so that the vision-detecting element 3 can clearly read the vision of the object's surface 4. Using a circuit control unit and based on the vision variation of the moving object's surface 4, data such as the moving direction and moving distance of the input device on the object's surface can be determined.

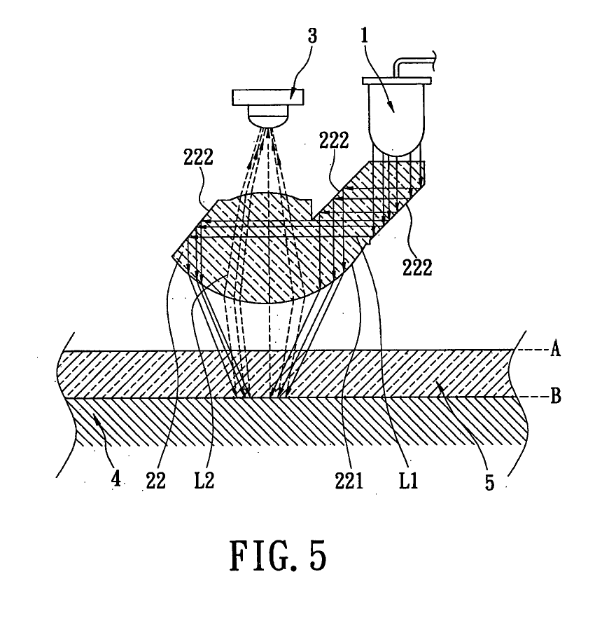

FIG. 5 is a cross-sectional view according to a second embodiment of the present invention. As shown in FIG. 5, the light source 5 can be vertically arranged to let the beam projecting path L1 of the projecting beam of the light source 1 be not able to be directly incident to the arch 221 of the first lens 22. Several slanting prisms 222 are disposed around the first lens 22. At least one of the slanting prisms 222 is exactly on the beam projecting path L1, and at least two of the slanting prisms 222 achieve mutual reflection. The projecting beam is reflected by the slanting prisms 222 to be incident to the arch 221 of the first lens 22.

In the above structure, the beam of the light source 1 is first incident to a slanting prism 222 below the light source 1. The beam projecting path L1 of the light source 1 is guided by the slanting prism 222 to be horizontally incident to another slanting prism 222. The beam projecting path L1 of the light source 1 is then guided by this slanting prism 222 to be vertically incident to arch 221 of the first lens 22. In this way, the function of guiding the beam to the arch 221 can be accomplished.

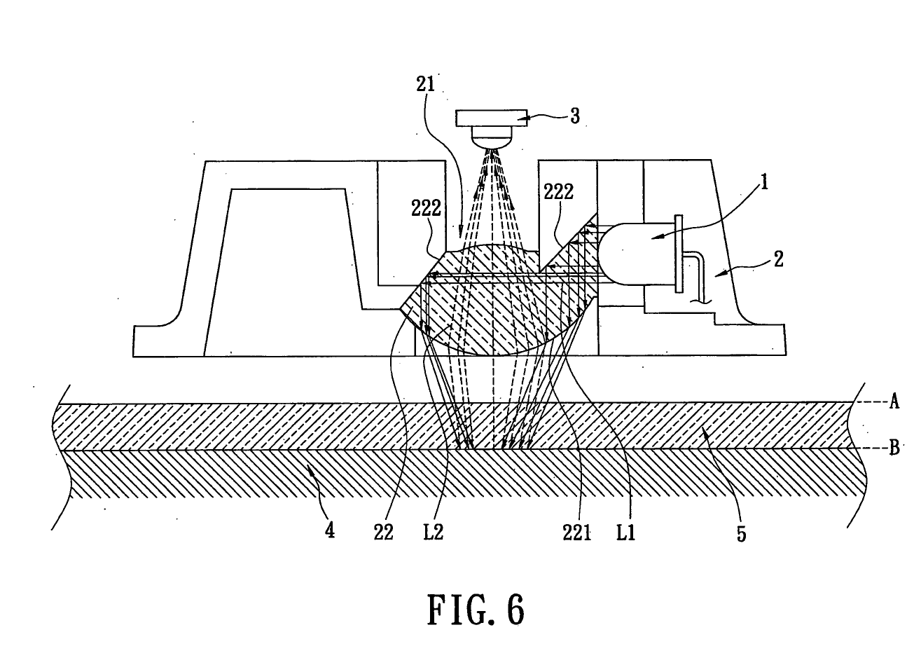

FIG. 6 is a cross-sectional view according to a third embodiment of the present invention. As shown in FIG. 6, the light source 1 and the first lens 22 are received in a lens base 2. The lens base 2 is integrally formed of a transparent material. A room 21 is formed on the beam projecting path L1 of the light source 1 and the beam reflecting path L2. The first lens 22 is arranged in the room 21.

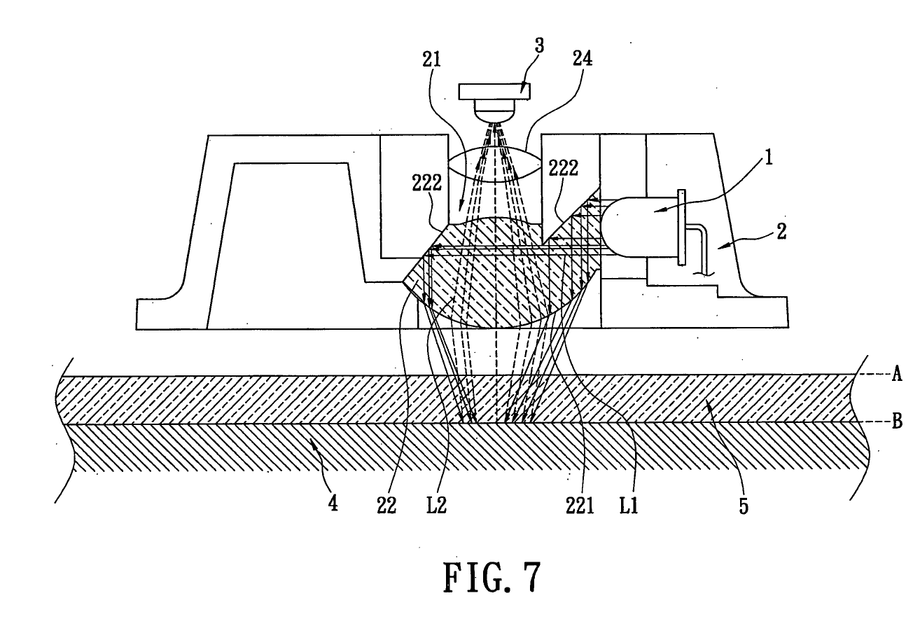

FIG. 7 is a cross-sectional view according to a fourth embodiment of the present invention. As shown in FIG. 7, at least a second lens 24 for adjusting the vision effect is disposed on the vision-capturing path L2 between the vision-detecting element 3 and the first lens 22 to adjust the definition of vision, thereby letting the vision-detecting element acquire better vision.

In the above structure, the vision on the object's surface 4 is further adjusted via the second lens 24 disposed on the vision-capturing path L2, and is then incident to the vision-detecting element 3 so that the vision captured by the vision-detecting element 3 can be brighter and clearer.

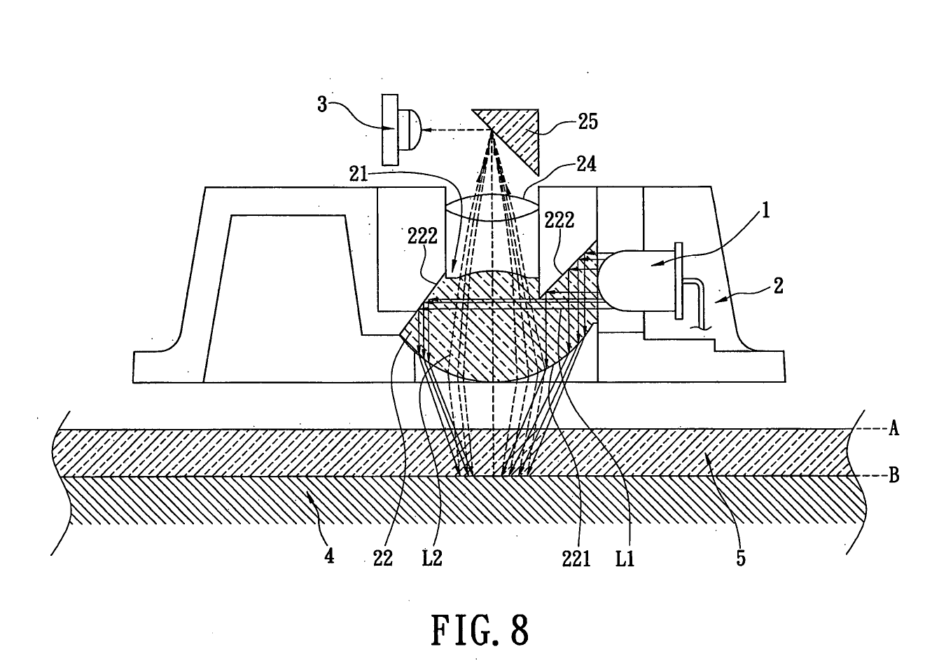

FIG. 8 is a cross-sectional view according to a fifth embodiment of the present invention. As shown in FIG. 8, at least a reflecting mirror 25 is disposed above the room 21 of the lens base 2 and between the vision-detecting element 3 and the first lens 22. The reflecting mirror 25 is exactly on the vision capturing path L2 and used to guide the vision to the vision-detecting element 3.

In the above structure, it is not necessary for the vision-detecting element 3 to be on the normal of the arch 221 of the first lens 22. The vision capturing path L2 can be changed via the reflecting mirror 25 to let the vision capturing path L2 be correspondingly incident to the vision-detecting element 3.

To sum up, the present invention has the following advantages:
1. The present invention makes use of the arch 221 of the first lens 22 to focus the incident beam so that the beam projecting path can penetrate the surface of the transparent dielectric object 5 (e.g., glass) exactly below the first lens 22 and be incident to the object's surface 4 below the transparent dielectric object 5, thereby letting the vision of the object's surface 4 be clearly captured.
2. The present invention focuses the beam via the arch 221 to reduce the loss of beam energy and let the light source 1 of equal light emission power accomplish the maximum beam intensity. The vision of the object's surface can thus be clearly captured, and the light power output can be relatively saved to fully take advantage of light energy. In an era of energy shortage, this is an environmental and economic design.
3. In the present invention, the beam incident to the object's surface 4 is focused toward the center, and the normal of the first lens 22 is perpendicular to the object's surface. Therefore, the beam projecting path L1 and the vision capturing path L2 almost overlap each other to avoid the refraction influence caused by to-and-fro passing of beam in the transparent dielectric object 5. Therefore, the vision of the object's surface 4 can be successfully and clearly captured.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A beam-directed structure of an input device disposed in a main body of said input device, comprising:
a light source used to provide a projecting beam;
a first lens whose bottom has an arch is on the path of the beam's projection, said arch being used to adjust the beam's slope to make the beam focus on an surface of an object under the first lens's bottom, a vision-capturing path passing through said first lens exactly from the surface of the object and focusing on an upper part of said first lens; and
a vision-detecting element mounted on the upper part of said first lens and used to collect a vision from the surface of the object.

2. The beam-directed structure as claimed in claim 1, wherein said light source is an invisible light source.

3. The beam-directed structure as claimed in claim 1, wherein said light source is a visible light source.

4. The beam-directed structure as claimed in claim 1, wherein said light source is a laser.

5. The beam-directed structure as claimed in claim 1, wherein said light source is a light emitting diode.

6. The beam-directed structure as claimed in claim 1, wherein at least an inclined prism is disposed on said projecting path of said light source around said first lens to direct the beam to be reflected once or more and then enter into said arch of said first lens.

7. The beam-directed structure as claimed in claim 6, wherein at least one of said inclined prism is disposed above at least one side opposite to said arch of said first lens.

8. The beam-directed structure as claimed in claim 6, wherein at least one of said inclined prism is disposed above each side opposite to said arch of said first lens.

9. The beam-directed structure as claimed in claim 6, wherein at least two of said inclined prisms are disposed around said first lens to accomplish mutual reflection to let the beam be reflected once or more and then enter into said arch.

10. The beam-directed structure as claimed in claim 7, wherein at least two of said inclined prisms are disposed around said first lens to accomplish mutual reflection to let the beam be reflected once or more and then enter into said arch.

11. The beam-directed structure as claimed in claim 8, wherein at least two of said inclined prisms are disposed around said first lens to accomplish mutual reflection to let the beam be reflected once or more and then enter into said arch.

12. The beam-directed structure as claimed in claim 1, wherein said first lens is a convex lens, and said arch is formed at a bottom of said first lens.

13. The beam-directed structure as claimed in claim 1, wherein said vision-detecting element is on the normal of said first lens.

14. The beam-directed structure as claimed in claim 11, wherein at least a second lens is disposed on said vision-capturing path between said vision-detecting element and said first lens to adjust the definition of vision.

15. The beam-directed structure as claimed in claim 1, wherein at least a reflecting mirror is disposed between said vision-detecting element and said first lens and exactly on said vision-capturing path to reflect a vision to said vision-detecting element.

16. The beam-directed structure as claimed in claim 1, wherein a lens base is disposed in said main body of said input device, a room in said lens base is exactly on said projecting path of the beam and said vision-capturing path, and said first lens is arranged in said room.

17. The beam-directed structure as claimed in claim 16, wherein said second lens is disposed in said room relative to a top of said first lens.
